(19) United States
(12) Patent Application Publication
(10) Pub. No.: US 2021/0333122 A1
(43) Pub. Date: Oct. 28, 2021

(54) BIASING REROUTES TO A SET ROUTE

(71) Applicant: Uber Technologies, Inc., San Francisco, CA (US)

(72) Inventors: Karapet Shaginyan, San Francisco, CA (US); Vineet Khosla, Pacifica, CA (US); Joseph Barker, Portland, OR (US); Rifat Berk, San Francisco, CA (US)

(21) Appl. No.: 16/856,452

(22) Filed: Apr. 23, 2020

(51) Int. Cl. G01C 21/36; G01C 21/34

(52) U.S. Cl. CPC G01C 21/3655; G01C 21/3415; G01C 21/3679; G01C 21/3453; G01C 21/343; G01C 21/3664

(57) ABSTRACT

Systems and methods for biasing reroute to a user selected alternate route or a required route segment is provided. A network system receives an origin and a destination and determines a plurality of routes to navigate from the origin to the destination. The plurality of routes includes an optimal route and an alternate route. The network system receives, from a user device, a selection of the alternate route for navigation. The network system then monitors navigation of the alternate route by a user associated with the user device and detects deviation from the alternate route. In response to the detection, the network system determines a reroute by biasing to the alternate route over the optimal route. The reroute is then presented on the user device.

### TECHNICAL FIELD

The subject matter disclosed herein generally relates to special-purpose machines configured for routing to a destination, and to the technologies by which such special-purpose machines become improved compared to other machines that route to a destination. Specifically, the present disclosure addresses systems and methods that bias rerouting when a driver deviates from a set route that includes either a user selected alternate route or a required route segment.

### BACKGROUND

In some cases, navigation systems provide drivers with an optimal or most direct route to a destination as well as alternate routes to the destination, and drivers can select one of the alternate routes instead of the optimal or most direct route to destinations. If the driver deviates from the alternate route (e.g., makes a wrong turn, stops for gas or food), conventional systems may disregard a driver's selected alternate route and fall back to the optimal route or suggest a new optimal route from a current location of the driver.

### BRIEF DESCRIPTION OF THE DRAWINGS

Some embodiments are illustrated by way of example and not limitation in the figures of the accompanying drawings.

FIG. 1 is a diagram illustrating a network environment suitable for biasing reroutes to a set route, according to some example embodiments.

FIG. 2 is a block diagram illustrating components of a network system for biasing reroutes to the set route, according to some example embodiments.

FIG. 3 is a flowchart illustrating operations of a method for biasing reroutes to a user selected alternate route, according to some example embodiments.

FIG. 4 is a flowchart illustrating operations of a method for biasing reroutes to a required route or route segment, according to some example embodiments.

FIG. 5 is a diagram illustrating potential reroute nodes on a set route, according to some example embodiments.

FIG. 6 is a flowchart illustrating operations of a method for determining a reroute using node rerouting, according to some example embodiments.

FIG. 7 is a block diagram illustrating components of a machine, according to some example embodiments, able to read instructions from a machine-readable medium and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present disclosure provides technical solutions for biasing reroutes to a set route. In some embodiments, the set route comprises an alternate route selected by a user (e.g., a driver or a rider). In some embodiments, the user provides a destination and, in some cases, an origin (or the origin is detected to be the user's current location). In some embodiments, the destination and/or origin are provided by a remote network system or server associated with a transportation service. A network system determines a plurality of routes from the origin to the destination that includes an optimal route and one or more alternate routes. The optimal route may be a fastest route, a shortest route, and/or a lowest cost route. The alternate routes may be routes that are based on client preferences (e.g., avoid freeways, avoid hills, scenic route, frequently driven route), are frequently driven by other users of the network system, or selected by the network system based on other criteria. The user then selects one of the alternate routes for navigation to the destination.

In other embodiments, the set route comprises a required route or route segment between the origin and the destination. For example, some airports require vehicles to be routed through a fixed path defined by airport regulators. In yet another example, some high capacity vehicles (e.g., freight truck, bus) are required to travel through a fixed path or segment in certain locations.

The network system then monitors navigation of the set route and detects deviation from the set route. In response to the detection, the network system determines a reroute by biasing to the set route over any other route that may be available. The biasing may include one or more of increasing costs for route segments not a part of the set route, decreasing costs for route segments that are a part of the set route, or forcing a reroute to a node of the set route having a lowest cost from a user's current location to the destination. The reroute is then presented on the user device.

Therefore, example methods (e.g., algorithms) and example systems (e.g., special-purpose machines) are configured to preserve a user's selected alternate route or force a user to follow a required route segment by biasing any deviations from a set route back to the set route. As such, one or more of the methodologies described herein facilitate solving the technical problem of routing vehicles to a destination that preserves a user's preferences and/or any required route segments.

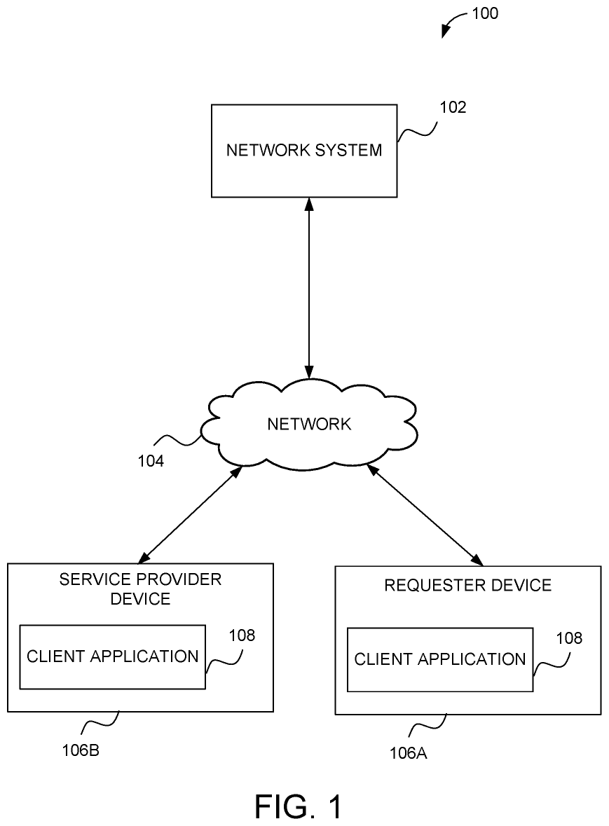

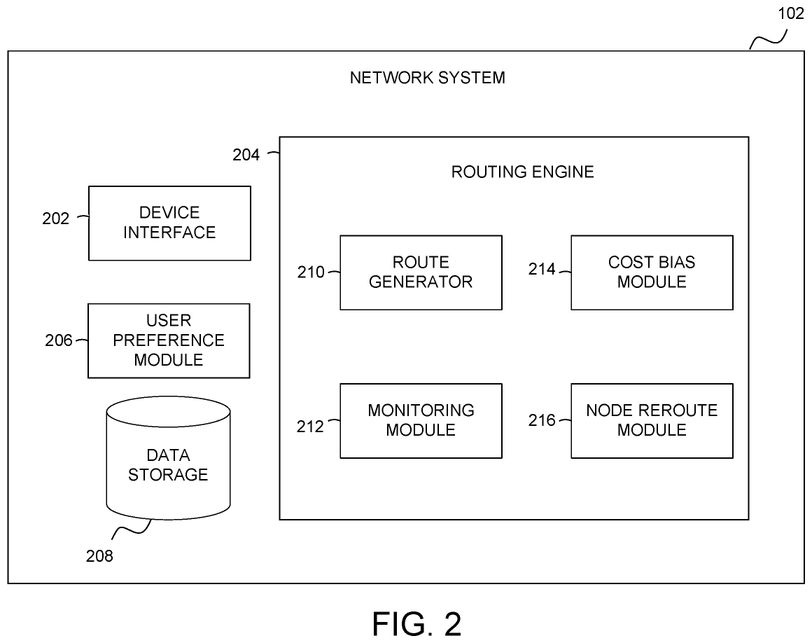

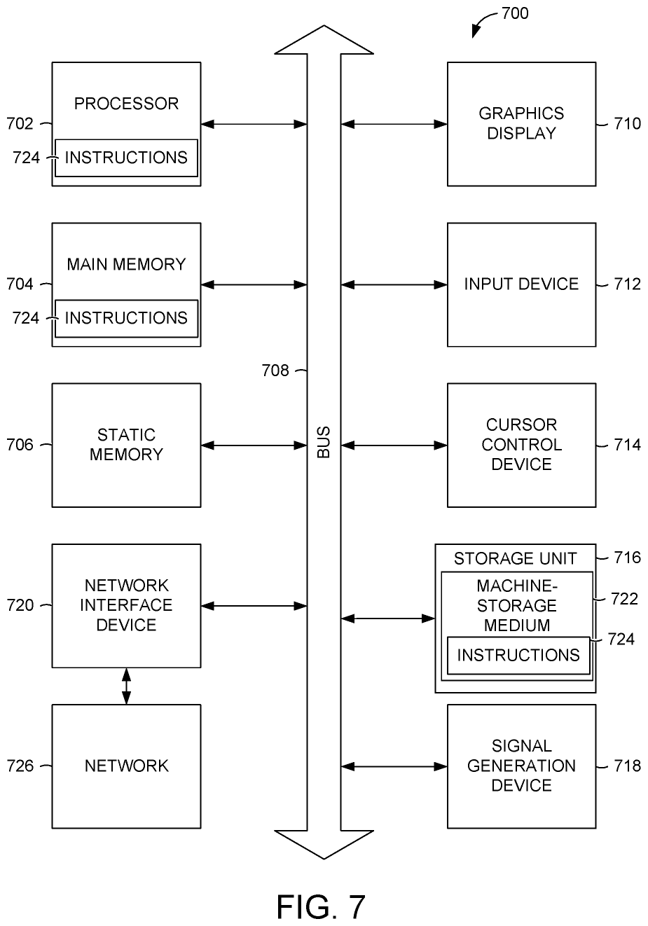

FIG. 1 is a diagram illustrating a network environment 100 suitable for biasing a reroute to a set route, in accordance with example embodiments. The network environment 100 includes a network system 102 communicatively coupled via a network 104 to a requester device 106a of a user or rider and a service provider device 106b of a driver (collectively referred to as “user devices 106”). In example embodiments, the network system 102 comprises components that obtain, store, and analyze trip data received from the user devices 106 in order to determine routes traveled in past trips and learn user preferences from the past trips. Trip data also includes (substantially) real-time trip data that allows the network system 102 to monitor a location of users (via their user devices) and detect if they have deviated from a set route (e.g., a user selected alternate route, a required route or route segment). The network system 102 then determines a reroute to get the users back on course to their destination, whereby the reroute is biased to the set route. The components of the network system 102 are described in more detail in connection with FIG. 2 and may be implemented in a computer system, as described below with respect to FIG. 7. While some embodiments are described in the context of a transportation service (e.g., to transport a person or item), example embodiments may be used in any navigation embodiment (e.g., personal navigation of a vehicle to a destination).

The components of FIG. 1 are communicatively coupled via the network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 104 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In example embodiments, the user devices 106 are portable electronic devices such as smartphones, tablet devices, wearable computing devices (e.g., smartwatches), or similar devices. Alternatively, the service provider device 106b can correspond to an on-board computing system of a vehicle. The user devices 106 each comprises one or more processors, memory, touch screen displays, wireless networking system (e.g., IEEE 802.11), cellular telephony support (e.g., LTE/GSM/UMTS/CDMA/HSDP A), and/or location determination capabilities. The user devices 106 interact with the network system 102 through a client application 108 stored thereon. The client application 108 of the user devices 106 allow for exchange of information with the network system 102 via user interfaces, as well as in background. For example, the client application 108 running on the user devices 106 may determine and/or provide location information of the user devices 106 (e.g., current location in latitude and longitude) and speed to the network system 102, via the network 104, for analysis and storage. In example embodiments, the location information is used by the network system 102 to detect when and where a user has deviated from the set route. The network system 102 then determines and provides reroute information to the user devices 106.

In example embodiments, a first user (e.g., a requester or rider) operates the requester device 106a that executes the client application 108 to communicate with the network system 102 to make a request for a transportation service such as transport or delivery service (referred to collectively as a “trip”). In some embodiments, the client application 108 determines or allows the user to specify/select a pickup location (e.g., of the user or an item to be delivered) and to specify a drop-off location or destination for the trip. The client application 108 also presents information, from the network system 102 via user interfaces, to the user of the requester device 106a. For instance, the user interface can display a plurality of routes from which the first user can select from to travel to the destination and/or display navigation along a map.

A second user (e.g., a service provider or driver) operates the service provider device 106b to execute the client application 108 that communicates with the network system 102 to exchange information associated with providing transportation service (e.g., to the user of the requester device 106a). The client application 108 presents information via user interfaces to the user of the service provider device 106b, such as invitations to provide the transportation service, a plurality of routes from which the second user can select from to travel to the destination, and/or navigation instructions. The client application 108 also provides data to the network system 102 such as a current location (e.g., coordinates such as latitude and longitude), speed, and/or heading of the service provider device 106b or vehicle.

In example embodiments, any of the systems, machines, databases, or devices (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 7, and such a special-purpose computer may be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or devices illustrated in FIG. 1 may be combined into a single system or device, and the functions described herein for any single system or device may be subdivided among multiple systems or devices. Additionally, any number of user devices 106 may be embodied within the network environment 100. Furthermore, some components or functions of the network environment 100 may be combined or located elsewhere in the network environment 100. For example, some of the functions of the networked system 102 may be embodied within other systems or devices of the network environment 100. Additionally, some of the functions of the user device 106 may be embodied within the network system 102. While only a single network system 102 is shown, alternative embodiments may contemplate having more than one network system 102 to perform server operations discussed herein for the network system 102.

FIG. 2 is a block diagram illustrating components of the network system 102, according to some example embodiments. In various embodiments, the network system 102 obtains and analyzes trip data (e.g., indicated origin and destination, route selection, locations of user devices, speed) received from the user devices 106, determines whether a user device 106 has deviated from a set route, and determines a reroute to the destination that biases to the set route. To enable these operations, the network system 102 comprises a device interface 202, a routing engine 204, a user preference module 206, and a data storage 208 all configured to communicate with each other (e.g., via a bus, shared memory, or a switch). The network system 102 may also comprise other components (not shown) that are not pertinent to example embodiments. Furthermore, any one or more of the components (e.g., engines, interfaces, modules, storage) described herein may be implemented using hardware (e.g., a processor of a machine) or a combination of hardware and software. Moreover, any two or more of these components may be combined into a single component, and the functions described herein for a single component may be subdivided among multiple components.

The device interface 202 is configured to exchange data with the user devices 106 and cause presentation of one or more user interfaces provided by the network system 102 on the user devices 106 including user interfaces to initiate a request for transportation service, display invitations to provide the transportation service on the service provider device 106b, for selecting a route from a plurality of routes, for displaying a map and/or navigation instructions, and for providing notifications. The device interface 202 receives an indication of the origin and destination for a trip. The device interface 202 may also receive a selection of an alternate route that is presented to a user. The selection may be from either a requester or a service provider depending on the embodiment.

The routing engine 204 manages generating routes, monitoring navigation of routes, and rerouting to a set route when a user deviates from the set route. To enable these operations, the routing engine 204 comprises a route generator 210, a monitoring module 212, a cost bias module 214, and a node reroute module 216.

The route generator 210 is configured to generate routes from an origin to a destination using any route generation systems or algorithms known to those skilled in the art. In example embodiments, the generated routes include an optimal route that is optimal based on the route being the fastest route, shortest route, or lowest cost route. The generated routes also include alternate routes. The alternate routes may be routes that are based on user preferences (e.g., avoid freeways, avoid hills, scenic route, frequently driven route), are frequently driven or selected by other users of the network system, or selected by the network system based on other reasons. For example, an alternate route may be a route that does not have the lowest cost but is faster than an optimal route identified as being the lowest cost route. In example embodiments, the cost of a route may be a sum of costs for each route segment along the route. As understood by those skilled in the art, the “cost” of a route or a route segment (e.g., a road segment) may indicate some type of cost that is expected to be incurred in order to traverse that route or route segment, such as a time-based cost indicating the amount of time it takes to traverse the route or route segment, or a distance-based cost indicating the amount of distance to travel in order to traverse the route or route segment.

The plurality of routes identified by the route generator 210 are presented to the user, via their user device 106, by the device interface 202. In some embodiment, the plurality of routes is present to a service provider on the service provider device 106b. Because the service provider will be navigating a vehicle to the destination, the service provider is provided the ability to select the route they would like to navigate. In an alternative embodiment, the plurality of routes is provided to a requester at the requester device 106a thus giving the requester the ability to select the route to travel to the destination.

The selection of an alternate route (over the optimal route) is made by the user and received by the device interface 202. A user (e.g., service provider) then begins navigating along the alternate route. The monitoring module 212 monitors navigation of the set route (e.g., the selected alternate route). In example embodiments, the monitoring module 212 may receive location information (e.g., GPS coordinates) from the user device 106 and determine whether the location information indicates that the user is still navigating along the set route. If the user deviates from the set route, the monitoring module 212 detects that deviation along with a point where the user deviated from the set route.

The deviation triggers the routing engine 204 to determine a reroute to the destination that biases to the set route. This is done in an attempt to preserve the user's preference. In some embodiments, the cost bias module 214 is configured to determine the reroute by biasing costs. In particular, the cost bias module 214 increases costs for route segments there are not a part of the set route (e.g., the alternate route), decreases costs for route segments that are a part of the set route, and/or a combination of both. In some cases, the cost bias module 214 receives an indication of the user's selected alternate route from the user preference module 206 for use in the biasing. By increasing costs for route segment that are not a part of the set route or decreasing costs for route segments that are a part of the set route, the reroute will be biased towards redirecting the user to the set route. Once biased, the route generator 210 generates the reroute based on the biasing.

In some embodiments, the deviation triggers the node reroute module 216 to determine the reroute to the destination that biases to the set route. As indicated above, convention systems typically reroute by generating a new optimal route from a current location to the destination. This may result in a disregard of the user's selected alternate route. The node reroute module 216 attempts to preserve the user's selected alternate route by trying to reroute the user back to nodes along the set route. The nodes may be behind or ahead of a point of deviation on the set route or be the point of deviation, itself In example embodiments, the nodes are chosen within a predefined radius of the current location of the user. For example, the predefined radius can be one kilometer although any radius may be used. In some embodiments, the predefined radius is adjusted or is based on a type of road associated with the current location of the user, the point of deviation, or the set route. For instance, if the type of road is a freeway, the radius may be made larger while the radius may be made smaller for a country road or city streets.

For each chosen node, the node reroute module 216 computes a sum of a cost from the current location of the user to the node and from the node to the destination along the set route. The node reroute module 216 then selects the node having a lowest sum of the costs from the current location to the node and from the node to the destination along the set route for the reroute. The route generator 210 then determines instructions for the reroute to the selected node and the device interface 202 presents the reroute and instructions on the user device 106.

In one embodiment, the node reroute module 214 or the route generator 210 may determine that the lowest sum of the costs from the current location to the node and from the node to the destination along the set route for the reroute exceeds a predetermined reroute cost threshold. In response to this determination, the route generator 210 is configured to determine a new optimal route from the current location of the user to the destination and a cost for the new optimal route. The route generator 210 then compares the lowest sum from the current location to the node and from the node to the destination along the set route for the reroute to the cost for the new optimal route and selects the lowest cost route for the reroute.

In some embodiments, the route generator 210 may decide to not reroute the user to the alternate route based on the user deviating a threshold number times. In particular, each deviation may trigger a counter that tracks a number of deviations during the navigation of the alternate route. The route generator 210 detects that the number of deviations has occurred a threshold number of times. In response to the detection, the route generator 210 determines a new optimal route from the current location of the user to the destination and the device interface 202 causes the new optimal route to be displayed on the user device 106. The new optimal route may be a shortest route, fastest route, or lowest cost route from the user's current location.

The user preference module 206 is configured to maintain and utilize user preferences. In example embodiments, the user preference module 206 receives a user (e.g., service provider/driver) selection of an alternate route and maintains that information during navigation of the alternate route to the destination. Should the user deviate from the alternate route, the user preference module 206 can provide an identification of the alternate route (e.g., a route identifier) to the routing engine 204 in order for the routing engine 204 to determine a reroute to the destination that biases to the alternate route.

The data storage 208 is configured to store information associated with each user of the network system 102 including trip data. The information includes various trip data used by the network system 102 to determine the plurality of routes including the alternate routes. For example, the stored information may indicate client preferences for avoiding freeways, avoiding hills, preferring scenic routes, or frequently driving certain routes. In some embodiments, the data is stored in or associated with a user profile corresponding to each user and includes a history of interactions using the network system 102. While the data storage 208 is shown to be embodied within the network system 102, alternative embodiments can locate the data storage 208 elsewhere and be communicatively coupled to the network system 102.

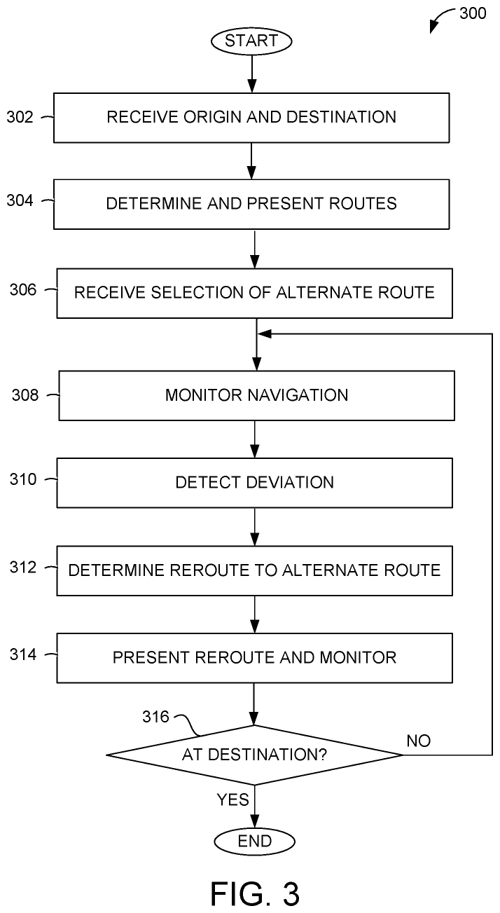

FIG. 3 is a flowchart illustrating operations of a method 300 for biasing reroutes to a user selected alternate route, according to some example embodiments. Operations in the method 300 may be performed by the network system 102, using components described above with respect to FIG. 2. Accordingly, the method 300 is described by way of example with reference to the network system 102. However, it shall be appreciated that at least some of the operations of the method 300 may be deployed on various other hardware configurations or be performed by similar components residing elsewhere in the network environment 100. Therefore, the method 300 is not intended to be limited to the network system 102.

In operation 302, the device interface 202 receives an indication of an origin and a destination for a trip. In example embodiments, the origin may be a pickup location of a service requester or a starting location of a trip. The origin and destination are then provided by the device interface 202 to the routing engine 204.

In operation 304, the routing engine 204 determines a plurality of routes from the origin to the destination. In example embodiments, the plurality of routes includes one or more alternate routes and an optimal route that is optimal based on the route being the fastest route, shortest route, or lowest cost route. The alternate routes may be routes that are based on user preferences, are frequently taken by the user, are frequently taken by other users of the network system, or selected by the network system based on other criteria. The alternate route may be a route that does not have the lowest cost, be the fastest route, or be the shortest route as compared to the optimal route. Subsequently, the device interface 202 causes presentation of the plurality of routes on the user device 106.

In operation 306, the device interface 202 receives a selection of an alternate route (also referred to as the “set route” in various embodiments) from the plurality of routes. The user then begins navigating along the set route.

In operation 308, the monitoring module 212 monitors navigation of the set route. In example embodiments, the monitoring module 212 may receive location information (e.g., GPS coordinates) from the user device 106 and determine whether the location information indicates that the user is still navigating along the set route.

In operation 310, the monitoring module 212 detects that deviation from the set route has occurred. In some cases, the monitoring module 212 determines a point or location where the user deviated from the set route.

The deviation triggers the routing engine 204 to determine a reroute to the destination that biases to the set route in operation 312. This is done in an attempt to preserve the user's preference. In some embodiments, the cost bias module 214 is configured to determine the reroute by biasing costs. In particular, the cost bias module 214 increases costs for route segments there are not a part of the set route, decreases costs for route segments that are a part of the set route, and/or a combination of both. In some cases, the cost bias module 214 receives an indication of the user's set route from the user preference module 206. By increasing costs for route segment that are not a part of the set route or decreasing costs for route segments that are a part of the set route, the reroute will be biased towards redirecting the user to the set route. Once biased, the route generator 210 generates the reroute based on the biasing.

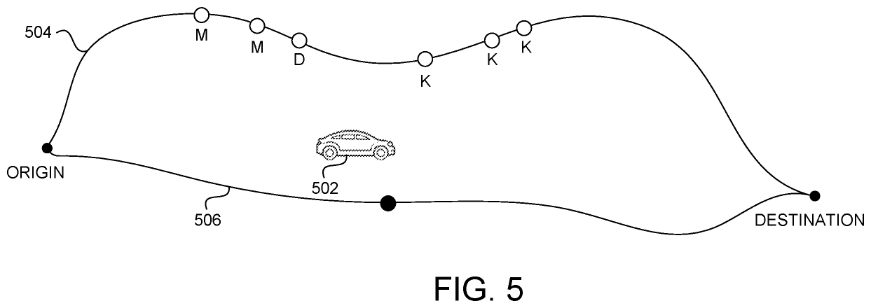

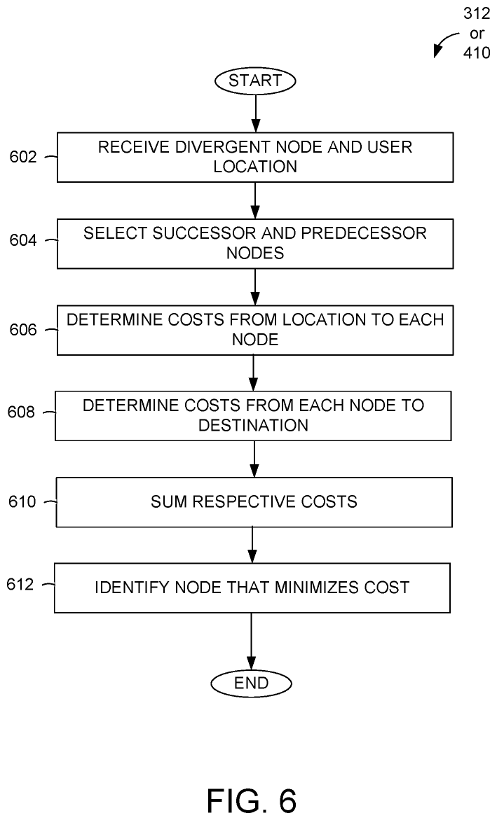

In some embodiments, the deviation triggers the node reroute module 216 to determine the reroute to the destination that biases to the set route instead or in addition to triggering the cost bias module 214. The operations of the node reroute module 216 are discussed in more detail in connection with FIG. 5 and FIG. 6 below.

In operation 314, the determined reroute is presented on the user device 106 (e.g., the service provider device 106b) and monitoring continues. A determination is made at operation 316 whether the user is at the destination. If the user is not at the destination, the method 300 returns to operation 308 where the monitoring module 212 continues monitoring navigation until the user arrives at the destination.

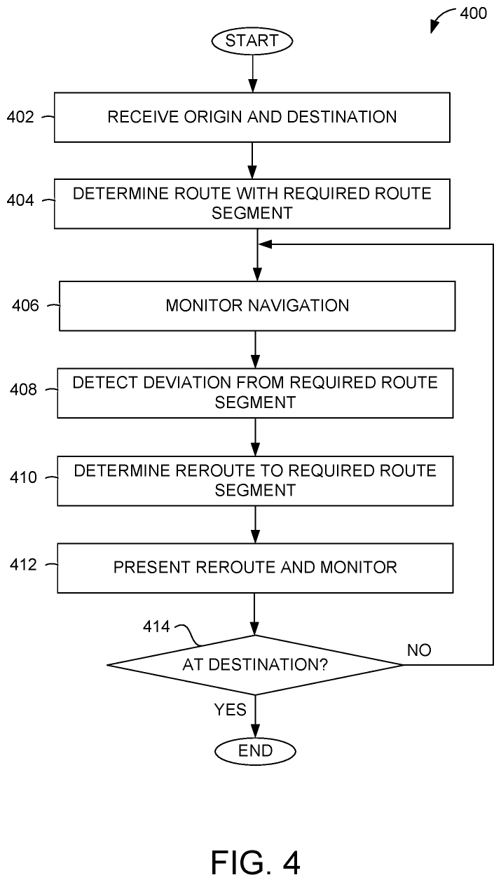

FIG. 4 is a flowchart illustrating operations of a method 400 for biasing reroutes to a required route, according to some example embodiments. Operations in the method 400 may be performed by the network system 102, using components described above with respect to FIG. 2. Accordingly, the method 400 is described by way of example with reference to the network system 102. However, it shall be appreciated that at least some of the operations of the method 400 may be deployed on various other hardware configurations or be performed by similar components residing elsewhere in the network environment 100. Therefore, the method 400 is not intended to be limited to the network system 102.

The method 400 involves a set route that comprises a required route or required route segment between the origin and the destination. For example, an airport may require vehicles to be routed through a fixed path defined by the airport or airport regulator. In another example, a high capacity vehicle (e.g., freight truck, bus) may be required to travel through a fixed path or route segment in certain locations or is barred from travelling other route segments. In these cases, the network system 102 monitors the vehicle (e.g., the user device 106 of the user) to ensure that the vehicle stays on, or is rerouted to, the set route. These embodiments may or may not include a user selection of an alternate route.

In operation 402, the device interface 202 receives an indication of an origin and a destination for a trip. In example embodiments, the origin may be a pickup location of a service requester or a starting location of a trip. The origin and destination are then provided by the device interface 202 to the routing engine 204.

In operation 404, the routing engine 204 determines a route to the destination that comprises a required path or required segment (referred to as the “set route”). The user then begins navigating along the set route.

In operation 406, the monitoring module 212 monitors navigation of the set route. In example embodiments, the monitoring module 212 may receive location information (e.g., GPS coordinates) from the user device 106 and determine whether the location information indicates that the user is still navigating along the set route.

In operation 408, the monitoring module 212 detects that deviation from the set route has occurred. In some cases, the monitoring module 212 determines a point or location where the user deviated from the set route.

The deviation triggers the routing engine 204 to determine a reroute that biases to the set route in operation 410. In some embodiments, the cost bias module 214 is configured to determine the reroute by biasing costs to favor the set route. Once biased, the route generator 210 generates the reroute based on the biasing. In other embodiments, the deviation triggers the node reroute module 216 to determine the reroute (e.g., instructions to reroute) to the set route. The operations of the node reroute module 216 are discussed in more detail in connection with FIG. 5 and FIG. 6 below.

In operation 412, the determined reroute is presented on the user device 106 (e.g., the service provider device 106b) and monitoring continues. A determination is made at operation 414 whether the user is at the destination. If the user is not at the destination, the method 400 returns to operation 406 where the monitoring module 212 continues monitoring navigation until the user arrives at the destination.

FIG. 5 is a diagram illustrating potential reroute nodes on a set route, according to some example embodiments. As shown, a vehicle 502 transporting the user has deviated from a set route 504 (e.g., a user selected alternate route) and is located between the set route 504 and an optimal route 506 (e.g., a route having a shortest distance from the origin to the destination). As shown in FIG. 5, a node (shown in black) that is on the optimal route 506 is closer to the vehicle 502. However, example embodiments preserve the user's preference to navigate along the set route which is a user selected alternate route. Therefore, instead of rerouting the vehicle 502 to the node on the optimal route 506, as conventional system may do, the vehicle is rerouted to the set route 504.

In example embodiments, the node reroute module 216 identifies a plurality of nodes (shown as open circles) to which to reroute the vehicle 502. The node reroute module 216 then determines a respective sum of a cost to travel to each node and a cost from each node to the destination as will be discussed in more details in FIG. 6.

As an example, suppose the car diverges from the set route 504 at node D (for divergence). The node reroute module 216 selects next K nodes that are successors of D and past M nodes that are predecessors of D (including D itself). For each of these K and M nodes, the routing engine 204 computes a sum of a cost from the vehicle 502 to the node and from the node to the destination following the set route 504. The routing engine 204 finds the node that minimizes that cost, whereby that node is designated C. The new reroute induced route-line is a stitching together of two route-lines: 1) a path from a current location of the vehicle 502 to C and 2) a path from C to the destination (following the set route 504).

FIG. 6 is a flowchart illustrating operations of a method (operation 312 or 410) for determining a reroute using node rerouting, according to some example embodiments. Operations in the method may be performed by the network system 102 and, in particular, the node reroute module 216. Accordingly, the method is described by way of example with reference to the network system 102. However, it shall be appreciated that at least some of the operations of the method may be deployed on various other hardware configurations or be performed by similar components residing elsewhere in the network environment 100. Therefore, the method is not intended to be limited to the network system 102.

In operation 602, the node reroute module 216 receives the divergent node and user location information. In example embodiments, the monitoring module 212 detects this information when detecting the deviation (operation 310 or 408) and provides this information to the node reroute module 216. In some cases, an identification of the set route (e.g., selected alternate route) may be provided by the user preference module 206 to the node reroute module 216.

In operation 604, the node reroute module 216 selects nodes to which to reroute the user that may include one or more successor nodes (behind the user's current location or point of deviation along the set route) and/or one or more predecessor nodes (ahead of the user's current location or point of deviation along the set route). The selected nodes may also include the point of deviation, itself In example embodiments, the nodes are chosen within a predefined radius of the current location of the user (e.g., one kilometer). In some embodiments, the predefined radius is adjusted or is based on a type of road associated with the current location of the user, the point of deviation, or the set route.

In operation 606, a cost from the current location to each of the chosen nodes is determined. Similarly, a cost from each chosen node to the destination is determined in operation 608. For each chosen node, the node reroute module 216 computes, in operation 610, a sum of the cost from the current location of the user to the node and from the node to the destination along the set route.

Once all the sums are determined, the node reroute module 216 selects the node that minimizes cost in operation 612. Specifically, the node reroute module 216 selects the node having a lowest sum of the costs from the current location to the node and from the node to the destination along the set route for the reroute. A reroute to the selected node is then determined and presented on the user device 106.

Various embodiments herein describe a set route that comprises an alternate route selected by a user. However, in other embodiments, the set route may comprise an optimal route (rather than an alternate route) selected by the user. For example, as described herein, the optimal route may be a fastest route, a shortest route, and/or a lowest cost route from an origin to a destination. If the user selects the optimal route and then the user later diverges from the optimal route, a new optimal route may be calculated by a navigation system from the current location of the user to the destination. Typically, this new calculated optimal route from the user's current location to the destination will correspond to the prior optimal route from the origin to the destination (since the new calculated optimal route should be the fastest route, the shortest route, and/or the lowest cost route from the user's current location to the destination). However, it is possible in some cases that the newly calculated optimal route may differ from the previous optimum route that was previously selected by the user (e.g., if the user has deviated by a large distance or if traffic conditions have changed). In such cases, the embodiments described herein can be applied to bias a reroute towards a previously selected optimum route of the user (e.g., even if it is no longer the fastest route, the shortest route, and/or the lowest cost route from the user's current location to the destination).

FIG. 7 illustrates components of a machine 700, according to some example embodiments, that is able to read instructions from a machine-storage medium (e.g., a machine-readable storage device, a non-transitory machine-readable storage medium, a computer-readable storage medium, or any suitable combination thereof) and perform any one or more of the methodologies discussed herein. Specifically, FIG. 7 shows a diagrammatic representation of the machine 700 in the example form of a computer device (e.g., a computer) and within which instructions 724 (e.g., software, a program, an application, an applet, an app, or other executable code) for causing the machine 700 to perform any one or more of the methodologies discussed herein may be executed, in whole or in part.

For example, the instructions 724 may cause the machine 700 to execute the flow diagrams of FIGS. 3, 4, and 6. In one embodiment, the instructions 724 can transform the general, non-programmed machine 700 into a particular machine (e.g., specially configured machine) programmed to carry out the described and illustrated functions in the manner described.

In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724 (sequentially or otherwise) that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 (e.g., a plasma display panel (PDP), a light emitting diode (LED) display, a liquid crystal display (LCD), a projector, or a cathode ray tube (CRT), or any other display capable of displaying graphics or video). The machine 700 may also include an input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a sound card, an amplifier, a speaker, a headphone jack, or any suitable combination thereof), and a network interface device 720.

The storage unit 716 includes a machine-storage medium 722 (e.g., a tangible machine-readable storage medium) on which is stored the instructions 724 (e.g., software) embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered as machine-readable media (e.g., tangible and non-transitory machine-readable media). The instructions 724 may be transmitted or received over a network 726 via the network interface device 720.

In some example embodiments, the machine 700 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 704, 706, and/or memory of the processor(s) 702) and/or storage unit 716 may store one or more sets of instructions and data structures (e.g., software) 724 embodying or utilized by any one or more of the methodologies or functions described herein. These instructions, when executed by processor(s) 702 cause various operations to implement the disclosed embodiments.

As used herein, the terms “machine-storage medium,” “device-storage medium,” “computer-storage medium” (referred to collectively as “machine-storage medium 722”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 722 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 722 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 724 may further be transmitted or received over a communications network 726 using a transmission medium via the network interface device 720 and utilizing any one of a number of well-known transfer protocols (e.g., HTTP). Examples of communication networks 726 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 724 for execution by the machine 700, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-storage medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

### EXAMPLES

Example 1 is a method for biasing reroute to a set route. The method comprises receiving, at a network system, an origin and a destination; determining, by the network system, a plurality of routes to navigate from the origin to the destination, the plurality of routes including an optimal route and an alternate route; receiving, from a user device by the network system, a selection of the alternate route for navigation; monitoring, by a processor of the network system, navigation of the alternate route by a user associated with the user device; detecting, by the network system, deviation from the alternate route; in response to the detecting, determining, by the network system, a reroute, the determining the reroute being based on biasing to the alternate route over the optimal route; and causing presentation of the reroute on the user device.

In example 2, the subject matter of example 1 can optionally include wherein the biasing to the alternate route comprises decreasing costs for route segments along the alternate route.

In example 3, the subject matter of any of examples 1-2 can optionally include wherein the biasing to the alternate route comprises increasing costs for route segments not a part of the alternate route.

In example 4, the subject matter of any of examples 1-3 can optionally include wherein the biasing to the alternate route comprises choosing nodes along the alternate route; for each chosen node, computing a sum of a cost from a current location of the user to the node and from the node to the destination along the alternate route; and selecting the node having a lowest sum of the costs from the current location to the node and from the node to the destination along the alternate route for the reroute.

In example 5, the subject matter of any of examples 1-4 can optionally include wherein choosing nodes along the alternate route comprises identifying nodes along the alternate route within a predefined radius of the current location.

In example 6, the subject matter of any of examples 1-5 can optionally include wherein the predefined radius is adjusted based on a type of road associated with the alternate route.

In example 7, the subject matter of any of examples 1-6 can optionally include determining that the lowest sum of the costs exceeds a predetermined reroute cost threshold; in response to determining that the lowest sum of the costs exceeds the predetermined reroute cost threshold, determining a new optimal route from the current location of the user to the destination and a cost for the new optimal route; and comparing the lowest sum to the cost for the new optimal route to select the reroute.

In example 8, the subject matter of any of examples 1-7 can optionally include detecting that deviation from the alternate route has occurred a threshold number times; in response to the detecting that the deviation has occurred the threshold number of times, determining a new optimal route from a current location of the user to the destination; and causing presentation of the new optimal route on the user device.

Example 9 is a system for biasing reroute to a set route. The system includes one or more processors and a memory storing instructions that, when executed by the one or more hardware processors, causes the one or more hardware processors to perform operations comprising receiving an origin and a destination; determining a plurality of routes to navigate from the origin to the destination, the plurality of routes including an optimal route and an alternate route; receiving, from a user device, a selection of the alternate route for navigation; monitoring navigation of the alternate route by a user associated with the user device; detecting deviation from the alternate route; in response to the detecting, determining a reroute, the determining the reroute being based on biasing to the alternate route over the optimal route; and causing presentation of the reroute on the user device.

In example 10, the subject matter of example 9 can optionally include wherein the biasing to the alternate route comprises decreasing costs for route segments along the alternate route.

In example 11, the subject matter of any of examples 9-10 can optionally include wherein the biasing to the alternate route comprises increasing costs for route segments not a part of the alternate route.

In example 12, the subject matter of any of examples 9-11 can optionally include wherein the biasing to the alternate route comprises choosing nodes along the alternate route; for each chosen node, computing a sum of a cost from a current location of the user to the node and from the node to the destination along the alternate route; and selecting the node having a lowest sum of the costs from the current location to the node and from the node to the destination along the alternate route for the reroute.

In example 13, the subject matter of any of examples 9-12 can optionally include wherein choosing nodes along the alternate route comprises identifying nodes along the alternate route within a predefined radius of the current location.

In example 14, the subject matter of any of examples 9-13 can optionally include wherein the predefined radius is adjusted based on a type of road associated with the alternate route.

In example 15, the subject matter of any of examples 9-14 can optionally include determining that the lowest sum of the costs exceeds a predetermined reroute cost threshold; in response to determining that the lowest sum of the costs exceeds the predetermined reroute cost threshold, determining a new optimal route from the current location of the user to the destination and a cost for the new optimal route; and comparing the lowest sum to the cost for the new optimal route to select the reroute.

In example 16, the subject matter of any of examples 9-15 can optionally include detecting that deviation from the alternate route has occurred a threshold number times; in response to the detecting that the deviation has occurred the threshold number of times, determining a new optimal route from a current location of the user to the destination; and causing presentation of the new optimal route on the user device.

Example 17 is a machine-storage medium storing instructions for biasing reroute to a set route. The machine-storage medium configures one or more processors to perform operations comprising receiving an origin and a destination determining a plurality of routes to navigate from the origin to the destination, the plurality of routes including an optimal route and an alternate route; receiving, from a user device, a selection of the alternate route for navigation; monitoring navigation of the alternate route by a user associated with the user device; detecting deviation from the alternate route; in response to the detecting, determining a reroute, the determining the reroute being based on biasing to the alternate route over the optimal route; and causing presentation of the reroute on the user device.

In example 18, the subject matter of example 17 can optionally include wherein the biasing to the alternate route comprises decreasing costs for route segments along the alternate route or increasing costs for route segments not a part of the alternate route.

In example 19, the subject matter of any of examples 17-18 can optionally include wherein the biasing to the alternate route comprises choosing nodes along the alternate route; for each chosen node, computing a sum of a cost from a current location of the user to the node and from the node to the destination along the alternate route; and selecting the node having a lowest sum of the costs from the current location to the node and from the node to the destination along the alternate route for the reroute.

In example 20, the subject matter of any of examples 17-19 can optionally include determining that the lowest sum of the costs exceeds a predetermined reroute cost threshold; in response to determining that the lowest sum of the costs exceeds the predetermined reroute cost threshold, determining a new optimal route from the current location of the user to the destination and a cost for the new optimal route; and comparing the lowest sum to the cost for the new optimal route to select the reroute.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
receiving, at a network system, an origin and a destination;
determining, by the network system, a plurality of routes to navigate from the origin to the destination, the plurality of routes including an optimal route and an alternate route;
receiving, from a user device by the network system, a selection of the alternate route for navigation;
monitoring, by a processor of the network system, navigation of the alternate route by a user associated with the user device;
detecting, by the network system, deviation from the alternate route;
in response to the detecting, determining, by the network system, a reroute, the determining the reroute being based on biasing to the alternate route over the optimal route; and
causing presentation of the reroute on the user device.

2. The method of claim 1, wherein the biasing to the alternate route comprises decreasing costs for route segments along the alternate route.

3. The method of claim 1, wherein the biasing to the alternate route comprises increasing costs for route segments not a part of the alternate route.

4. The method of claim 1, wherein the biasing to the alternate route comprises:
choosing nodes along the alternate route;
for each chosen node, computing a sum of a cost from a current location of the user to the node and from the node to the destination along the alternate route; and
selecting the node having a lowest sum of the costs from the current location to the node and from the node to the destination along the alternate route for the reroute.

5. The method of claim 4, wherein choosing nodes along the alternate route comprises identifying nodes along the alternate route within a predefined radius of the current location.

6. The method of claim 5, wherein the predefined radius is adjusted based on a type of road associated with the alternate route.

7. The method of claim 4, further comprising:
determining that the lowest sum of the costs exceeds a predetermined reroute cost threshold;
in response to determining that the lowest sum of the costs exceeds the predetermined reroute cost threshold, determining a new optimal route from the current location of the user to the destination and a cost for the new optimal route; and
comparing the lowest sum to the cost for the new optimal route to select the reroute.

8. The method of claim 1, further comprising:
detecting that deviation from the alternate route has occurred a threshold number times;
in response to the detecting that the deviation has occurred the threshold number of times, determining a new optimal route from a current location of the user to the destination; and
causing presentation of the new optimal route on the user device.

9. A system comprising:
one or more hardware processors; and
memory storing instructions that, when executed by the one or more hardware processors, cause the one or more hardware processors perform operations comprising:
receiving an origin and a destination;
determining a plurality of routes to navigate from the origin to the destination, the plurality of routes including an optimal route and an alternate route;
receiving, from a user device, a selection of the alternate route for navigation;
monitoring navigation of the alternate route by a user associated with the user device;
detecting deviation from the alternate route;
in response to the detecting, determining a reroute, the determining the reroute being based on biasing to the alternate route over the optimal route; and
causing presentation of the reroute on the user device.

10. The system of claim 9, wherein the biasing to the alternate route comprises decreasing costs for route segments along the alternate route.

11. The system of claim 9, wherein the biasing to the alternate route comprises increasing costs for route segments not a part of the alternate route.

12. The system of claim 9, wherein the biasing to the alternate route comprises:
choosing nodes along the alternate route;
for each chosen node, computing a sum of a cost from a current location of the user to the node and from the node to the destination along the alternate route; and
selecting the node having a lowest sum of the costs from the current location to the node and from the node to the destination along the alternate route for the reroute.

13. The system of claim 12, wherein choosing nodes along the alternate route comprises identifying nodes along the alternate route within a predefined radius of the current location.

14. The system of claim 13, wherein the predefined radius is adjusted based on a type of road associated with the alternate route.

15. The system of claim 12, wherein the operations further comprise:
determining that the lowest sum of the costs exceeds a predetermined reroute cost threshold;
in response to determining that the lowest sum of the costs exceeds the predetermined reroute cost threshold, determining a new optimal route from the current location of the user to the destination and a cost for the new optimal route; and
comparing the lowest sum to the cost for the new optimal route to select the reroute.

16. The system of claim 9, wherein the operations further comprise:
detecting that deviation from the alternate route has occurred a threshold number times;
in response to the detecting that the deviation has occurred the threshold number of times, determining a new optimal route from a current location of the user to the destination; and
causing presentation of the new optimal route on the user device.

17. A machine-storage medium storing instructions that, when executed by one or more hardware processors of a machine, cause the machine to perform operations comprising:
receiving an origin and a destination;
determining a plurality of routes to navigate from the origin to the destination, the plurality of routes including an optimal route and an alternate route;
receiving, from a user device, a selection of the alternate route for navigation;
monitoring navigation of the alternate route by a user associated with the user device;
detecting deviation from the alternate route;
in response to the detecting, determining a reroute, the determining the reroute being based on biasing to the alternate route over the optimal route; and
causing presentation of the reroute on the user device.

18. The machine-storage medium of claim 17, wherein the biasing to the alternate route comprises decreasing costs for route segments along the alternate route or increasing costs for route segments not a part of the alternate route.

19. The machine-storage medium of claim 17, wherein the biasing to the alternate route comprises:
choosing nodes along the alternate route;
for each chosen node, computing a sum of a cost from a current location of the user to the node and from the node to the destination along the alternate route; and
selecting the node having a lowest sum of the costs from the current location to the node and from the node to the destination along the alternate route for the reroute.

20. The machine-storage medium of claim 19, wherein the operations further comprise:
determining that the lowest sum of the costs exceeds a predetermined reroute cost threshold;
in response to determining that the lowest sum of the costs exceeds the predetermined reroute cost threshold, determining a new optimal route from the current location of the user to the destination and a cost for the new optimal route; and
comparing the lowest sum to the cost for the new optimal route to select the reroute.
